(19) United States
(12) Patent Application Publication
(10) Pub. No.: US 2012/0044320 A1
(43) Pub. Date: Feb. 23, 2012

(54) High resolution 3-D holographic camera

(75) Inventors: Brett Spivey, Carlsbad, CA (US); David Sandler, San Diego, CA (US); Paul A. Johnson, El Cajon, CA (US); Paul Fairchild, San Diego, CA (US); Louis Cuellar, Albuquerque, NM (US)

(73) Assignee: Trex Enterprises Corp.

(21) Appl. No.: 13/065,028

(22) Filed: Mar. 11, 2011

Related U.S. Application Data
(60) Provisional application No. 61/340,086, filed on Mar. 11, 2010.

(51) Int. Cl. H04N 5/89

(52) U.S. Cl. 348/40; 348/E05.024

(57) ABSTRACT

A high resolution 3-D holographic camera. A reference spot on a target is illuminated by three spatially separated beamlets (simultaneously produced from a single laser beam), producing a lateral shear of a wavefront on the target. The camera measures the resulting reflected speckle intensity pattern which are related the gradient of the interfered complex fields. At the same time a flood beam illuminates the entire target and reflected speckle is also recorded by the same camera to provide the necessary object spatial frequencies. The illumination patterns are sequenced in time, stepping through offset phase shifts to provide data necessary to reconstruct an image of the target from the recorded reflected light. The reference spot phase and amplitude are then reconstructed, and the reference spot's complex field is then digitally interfered with the flood illuminated speckle field by use of a special algorithm. In order to obtain a high resolution 3D image of the target, a second measurement is acquired with the laser beam slightly shifted in frequency to second color.

### CROSS REFERENCE TO RELATED APPLICATIONS

This application claims the benefit of Provisional Patent Application Ser. No. 61/340,086 filed Mar. 11, 2010.

### FIELD OF THE INVENTION

The present invention relates to cameras and in particular holographic cameras.

### BACKGROUND OF THE INVENTION

The technique of holography which was originally invented in 1947, and became practically utilized after the invention of the laser in 1960, has widely been used to generate 3-D images. In general, holograms are generated by interfering a laser beam that is scattered from an illuminate scene with a plane wave reference beam. This interference pattern is generally stored on a photographic emulsions or photographic polymers. A limitation of this method to generating a hologram is that the illuminated scene needs to be static to less than a wavelength of the laser beam during the recording of the hologram. This can lead to the limitation of only being able to record a static scene, or requiring the use of a short pulse laser in order to freeze the motion of the scene during the recording period.

Holograms, by their inherent nature of recording the amplitude and phase of the scattered beam from a scene, can generate 3-D images of the object. The 3-D depth resolution of the holographic scene is in practice limited by the stereoscopic parallax resolution estimated by the angular size of the recording medium in relation to the scene. In general, this depth resolution can only measure gross macroscopic depth profiles, and cannot determine to a high fidelity the very small depth variations of a scene at high spatial resolution. One method known as holographic interferometer can provide exceptional high depth resolution to less than the wavelength of the laser beam by recording two holograms and comparing the phase shifts between the two measurements. However, this only works well if the scene has a small change in the depth profile between the two measurements. Thus it has been utilized to measure stress and strain in materials by measuring the small deformation of the material.

A completely different technique known as white-light optical profilometry has been utilized to measure the 3-D profile of a target at high spatial resolution. However, this method is basically a single point measurement that is then scanned across the target. Therefore, it requires a significant amount of time to completely scan the target to obtain the full 3-D target profile. Also, it requires the target to be placed into a profilometer measuring device, and thus is not clandestine method to generate a high resolution 3-D profile.

In Speckle Holography (sometimes called Digital Holography) a detector array records the interference pattern between a reference and an object beam. The object beam is an illumination laser beam reflected off the target. The reference beam is often generated by splitting the illumination beam to into a separate path within the optical system, and then recombining the object and internal reference. An image of the object can be obtained through digital reconstruction of the speckled holographic pattern. A common method of retrieving the phase of the interference pattern is heterodyne detection. In our invention, we avoid the hardware complexities of using heterodyne detection. Heterodyne detection is also corrupted by phase errors arising from optical system aberrations, or aberrations caused by environmental disturbances between the object and detector, such as atmospheric turbulence. Our preferred approach is insensitive to these errors, which leads to simplifications in system architecture and more robust image reconstruction.

There is a significant prior art in heterodyne digital holography, and other holographic image reconstruction methods. An example is: P. S. Idell, J. R. Fienup and R. S. Goodman, “Image Synthesis from Nonimaged Laser Speckle Patterns,”. Opt. Lett. 12, 858-860 (1987).) lays out the general theory, and Feinup and Idell discuss possible system application in Ref 2 (J. R. Fienup and P. S. Idell, “Imaging Correlography with Sparse Arrays of Detectors,” Opt. Engr. 27, 778-784 (1988). A series of papers followed this work, focusing on the mathematical procedures required to extract object phase information from Fourier space measurements, including phase retrieval methods and support constraints for iterative techniques. Joseph C. Marron, Richard L. Kendrick, Nathan Seldomridge, Taylor D. Grow and Thomas A. Höft) have developed techniques to reduce the effect of phase errors in heterodyne digital holography. The use of more than one illumination wavelength allows 3-D images to be obtained, which incorporate object depth information; see for example Three-dimensional imaging using a tunable laser source, Opt. Eng. 39, 47 (2000); doi:10.1117/1.602334), and J. C. Marron and K. S. Schroeder, “Three-dimensional lensless imaging using laser frequency diversity,” Appl. Opt. 31, 255 (1992).

What is needed is a better high resolution 3-D holographic camera system.

### SUMMARY OF THE INVENTION

The present invention provides a high resolution 3-D holographic camera. A reference spot on a target is illuminated by three spatially separated beamlets (simultaneously produced from a single laser beam), producing a lateral shear of a wavefront on the target. The camera measures the resulting reflected speckle intensity pattern which are related the gradient of the interfered complex fields. At the same time a flood beam illuminates the entire target and reflected speckle is also recorded by the same camera to provide the necessary object spatial frequencies. The illumination patterns are sequenced in time, stepping through offset phase shifts to provide data necessary to reconstruct an image of the target from the recorded reflected light. The reference spot phase and amplitude are then reconstructed, and the reference spot's complex field is then digitally interfered with the flood illuminated speckle field by use of a special algorithm. In order to obtain a high resolution 3D image of the target, a second measurement is acquired with the laser beam slightly shifted in frequency to second color. The two measurements at slightly offset colors result in a synthetic wavelength measurement that is used to compute the depth profile of the illuminated target. Details of preferred embodiments of the invention are described in the attached document which is incorporate herein.

A Reference Spot Holography (RSH) technique, which efficiently produces all speckle data needed to reconstruct the object phase and amplitude, and which can be implemented using a COTS processor chip. RSH projects a sequence of illumination beams, for small spot on target (approximately 0.05-0.1 the width of the object dimension) to provide the data necessary to reconstruct the complex reference beam reconstruction required for holography. A flood illuminated beam of the entire target provides the necessary object spatial frequencies. To provide data necessary for the reconstruction algorithm, the illumination patterns are sequenced in time, stepping through offset phase shifts. The reference spot phase and amplitude are then reconstructed, and reference spot is digitally interfered with the flood illuminated speckle.

Applicants use a Sheared Beam Imaging (SBI) approach to generate intensity data which encodes the gradients of the reference spot speckle field. The illumination of the reference spot is formed by interference of three spatially separated beamlets (simultaneously produced from a single laser beam), producing a lateral shear of the wavefront. The resulting speckle intensity measurements thus produce the gradients of the desired object field, for reconstruction.

Applicants have developed a sheared beam reconstruction algorithm (SBI algorithm) which efficiently generates the complex reference phase and amplitude from phase gradients. The use of gradient measurements significantly reduces the oscillations in the speckle field, and allows for minimal speckle sampling (2×2 detector pixels/speckle). The SBI algorithm is very fast, and uses built-in noise weighting of gradient measurements. The RSH technique employs SBI reconstructions only on speckle data from a small reference spot illumination region. This effectively reduces the amount of data used by the reconstructor by 2-3 orders of magnitude.

Applicants use of two colors to obtain surface depth resolution. The frequency of the laser is adjusted by approximately 1 nm in wavelength, producing two distinct measured speckle fields, which are combined to produce depth resolution. Applicants' simulations demonstrate that two colors are sufficient. Applicants scalable detector design uses commercial 1 k×1 k silicon chips, tiled with negligible gap size, to acquire the intensity data over the required sub-field of view. The sensors have up to 600 Hz readout capacity, permitting timely acquisition of all the necessary data. Because Applicants' imaging technique reconstructs object phase and amplitude from intensity measurements (not heterodyne phase detection), the phase aberrations between target and detector do not affect phase of reconstructed amplitude. Applicants' compact beam projection unit consisting of a single holographic element can be produced using existing digital holography fabrication techniques. The phase offsets between successive RSH illuminations is produced by adjusting the position of the single laser beam on the hologram.

Potential use of compressive holography (CH) augments the RSH approach by increasing the number of voxels that may be inferred from the holographic recording, enabling multi-level reconstruction of features through transparent fabrics, lattice work or translucent (or non-focusing refractive) barriers. The technique allows for extremely deep fields-of-view, supporting simultaneous reconstruction in the Fresnel-Huygens, Fresnel and Fraunhaufer (far field) diffraction regions. CH will be studied as a method to be used in conjunction with RSH.

Applicants birefringent optical design enables simultaneous reception and segregation of closely-spaced laser wavelengths (nanometer-spacing) into adjacent pixels. This approach employs wide field-of-view high-order waveplate and birefringent grating technologies to enable optimum use of COTS sensor arrays with minimal system complexity. The resulting design reduces the required imager frame rate by 2× and results in a wide-field of view optical design with a minimum of complexity. This is not currently part of Applicants baseline approach, since all the necessary data for RSH can be obtained using commercial COTS sensor elements, so there appears to be no need to separate colors on the detector. But it offers a promising backup, and risk reduction technique, if the sensor read-out fall short of advertised specifications.

### BRIEF DESCRIPTION OF THE DRAWINGS

FIG. 1 is a layout of a sensor for a preferred embodiment of the present invention.

FIG. 2 shows processing electronics for a preferred embodiment.

FIG. 3 is a flow chart for a preferred reconstruction algorithm.

FIG. 4 shows beam steering optics for the preferred embodiment.

FIG. 5 illustrates a preferred beam forming technique.

FIG. 6 shows an optical layout for a laboratory demonstration of the present invention.

### DETAILED DESCRIPTION OF PREFERRED EMBODIMENTS

### Sensor and Processor

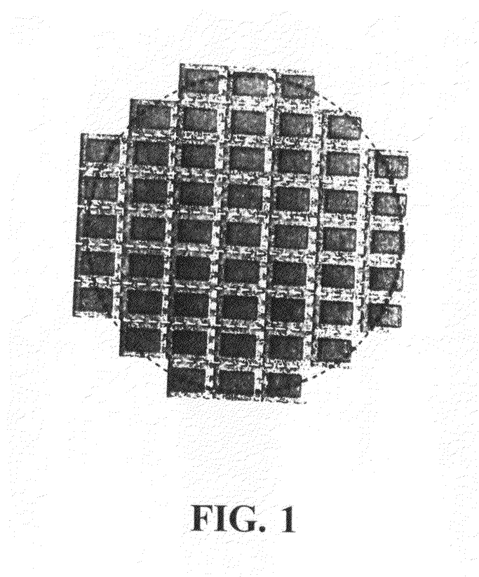

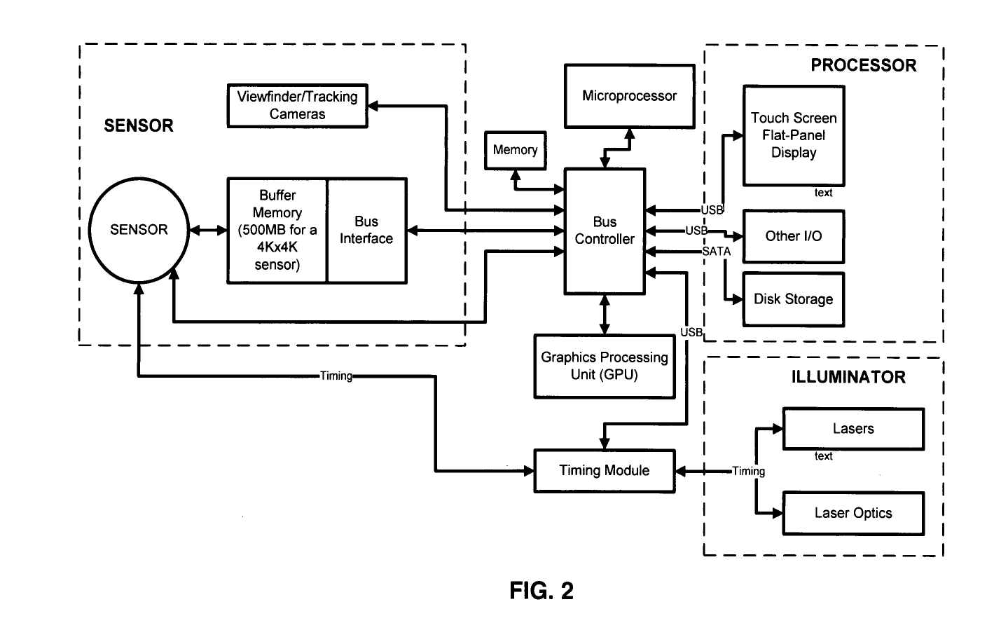

A preferred embodiment of the present invention includes a tiled sensor. A layout of the sensor is shown in FIG. 1. The sensor is built from commercial chips. The processing electronics is shown in FIG. 2. A major advantage of the approach used by Applicants is that the reconstructor processes phase/amplitude gradients with a special algorithm. The algorithm is an extension of the mathematical approach applied to adaptive optics, using a shearing interferometer wavefront sensor. It is very computationally efficient, does not require phase unwrapping, and its manipulations are performed directly on the desired complex amplitudes.

Preferred embodiments of the present invention includes three beamlets (formed using a single laser source), separated by shear distances. These beamlets propagate toward the target, overlapping, and interfere on the target, producing fringes. The reflected, optical field directly contains information on the target Fourier spectrum.

Because the beams are “sheared”, the speckle data at the receiver is that corresponding gradients of the speckle intensity, unaffected by atmospheric turbulence, since we measure intensity, not direct phase (no local oscillator). In order to separate the three gradients corresponding to the three relative baselines between the interference of the three fields, phase offsets are introduced between the projected three-beam pattern, through acousto-optic modulators, for example, or through use of holographic phase plate. This implies that the three-beam interference pattern contains “beats” between the three beams. If these phase differences are generated as a function of time (temporally stepping through the phase differences), a detection of the intensity patterns as a function of time is all that is needed for the SBI algorithm to extract the gradients (via Fourier transform in time), and then to process the complex gradients to give the pupil plan amplitude and phase of the object. To get the desired synthesized image, a final Fourier transform is performed.

Applicants emphasize that the SBI approach produces intensity data which encodes, into linear gradient terms, the desired object field. The “beats” are performed, simultaneously, in the target plane, so no heterodyne detection is required. There is no need to use image correlography, which has a long history, and then perform phase retrieval, which we have found to be very noise sensitive, and computationally cumbersome.

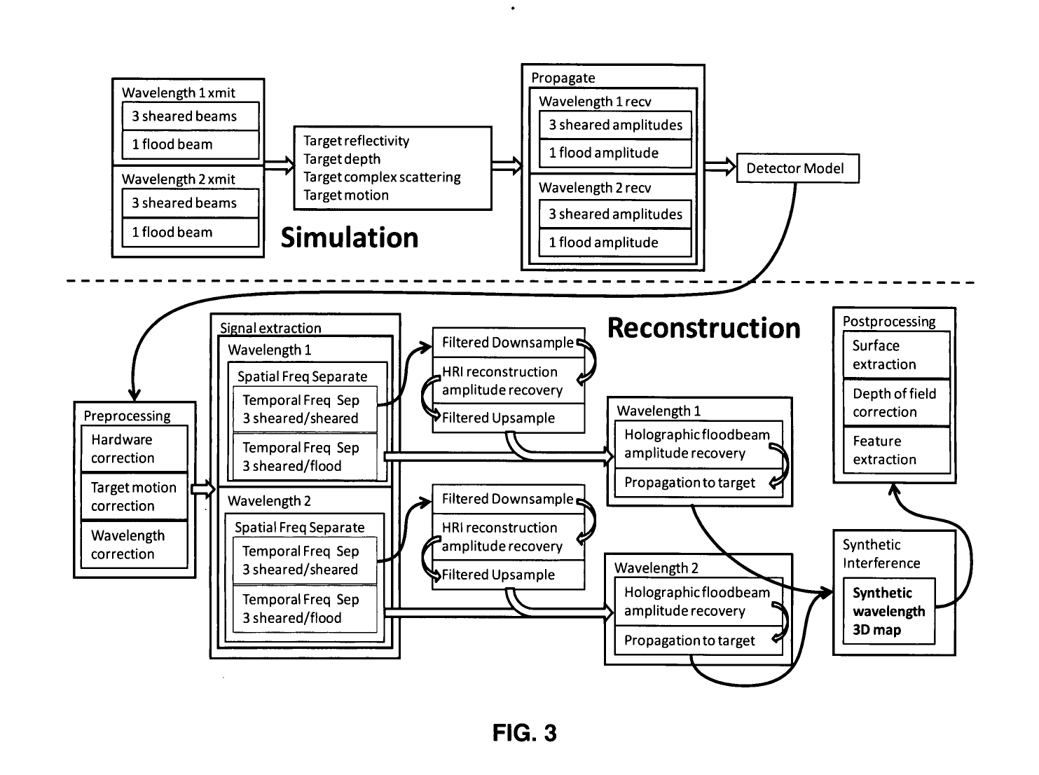

A major innovation in Applicants proposed approach is to implement the SBI reconstruction process on a sequence beats of single-spot data, illuminating the target. A flow chart of Applicants reconstruction algorithm is shown in FIG. 3. All spots are located in the same position at the target, as the relative phases between output beamlets are sequenced (through illumination of different portions of the holographic phase plate at the laser output). The illumination spot, for RSH, changes as a function of time, because of the sequence of phase shifts between beamlets. Instead of using SBI on a flood illumination interference triplet, the triplet is spot defined, drastically limiting the amount of data required in a data acquisition cycle. The high-spatial frequencies of the object are not obtained through detailed SBI reconstruction, but rather through interfering the SBI spots with the direct measurements of flood-illuminated speckle patterns of the entire object.

To acquire the necessary data for a complete 2-D object reconstruction, 6 sequenced beamlet configurations are projected, step by step in time, with phase between output triplets varied at each step. This gives the necessary combination of spatial-phase offset speckle patterns, to extract all phase gradients necessary for SBI reconstruction of the “spot reference” complex optical field. When Applicants add to this the flood illuminated speckle pattern, the total number of speckle intensity frames is 7, for one wavelength. Another wavelength is required to obtain depth information, at a longer synthesized wavelength. This brings to 14 the total number of detected frames, in the allotted data acquisition cycle. As Applicants show below, this is feasible using currently available silicon detectors.

| Approach | Method | Pros | Cons |
|---|---|---|---|
| Shirley et al, MIT/LL | Tunable frequency, | Good results for | Very computationally intensive, |
| | deconvolution | discrimination, | requires phase retrieval to meet FDOS |
| | | In principle gives all | system goals |
| | | data | |
| Maron, Fienup | Extension of MIT/LL | Impressive in | Computationally intensive, beyond |
| et al | work, detailed phase | literature, many | FDOS goals |
| | retrieval algorithm | patents | Non-linear algorithm |
| | | | Results for real targets not in literature |
| Single | Takes single | Trex demonstrated on | Unstable reconstructor, iterative |
| beam | transmitted laser | AFRL Active Imaging | and appears to be object |
| polarization | beam, using | Testbed, producing | dependent |
| approach | polarization element on | surveillance | Basic signal is small interference |
| | recr to take advantage | quality image of LEO | term, which may be negligible for |
| | of independence of | object | FDOS target set |
| | polarization, turbulence | | Works, but risky, and with |
| | effects | | considerable processing time |
| Fourier Telescopy | Developed to eliminate | Demonstrated by Trex | Not appropriate for WFOV |
| | the effects of speckle | for AFRL, for 1 km | Speckle reconstruction |
| | (which consume | horizontal path, to give | Tailored for use in NFOV |
| | inordinate image | 100 nm resolution | applications, where speckle is |
| | reconstruction time) for | Very simple robust | anathema |
| | SSA Objects | reconstruction | Great method for GEO imaging, |
| | Uses single photon- | algorithm, based on | since single large light bucket is |
| | counting detector to | phase closure | needed to acquire all the data for |
| | measure sweeping | Demonstrated in Trex | reconstruction |
| | fringe patterns on target | Active Imaging | |
| | | Laboratory, | |
| Fringe | Invented by Trex to | Successful DARPA | Best implemented for NFOV imaging |
| Imaging | give 2, 3 . . . nxDL | seedling has in Trex | systems, to increase resolution of |
| Telescopy | resolution, without | Active Imaging Lab | SWAP limited primary |
| | large optics, using | produced 3xDL imaging, | mirrors/aperture |
| | spatially, frequency | using fringe pattern of | Eliminates speckle effects, thereby |
| | diverse laser | laser beats across target, | allowing system to operate in |
| | transmitter array | imaged onto an APD- | snapshot mode (no need for |
| | | type detector | speckle averaging) |
| | | Ideal for NFOV | Requires NFOV, and recv steering optics |
| | | proximity detection, | |
| | | high-res target ID from | |
| | | airborne platforms | |
| Trex Sheared | Invented by Trex, | Resulted in | SSA objects require beating of all |
| Beam Imaging, | survived ONR/AFRL | successful, FDOS | spatial frequencies, across a large |
| full blown object | sponsored shootout of | Ph1-type lab | array of detectors |
| reconstruction | SCIP method I(Itek, | reconstruction | Speckle size/laser beam separation |
| w/o holography | 1989), because Trex | Very efficient | large due to large value of range Full |
| | time-based method | reconstruction of GEO- | SBI reconstructions untenable for |
| | superior (instead of | LEO objects, with large | FDOS, because of constraints on |
| | using static shear | array of photodiodes | Case 1-3 sizes, data acquisition, and |
| | prisms) | | reconstruction time requirements |
| | | | Overkill for FDOS |
| Arex RSH, using | Hybrid SBI approach, | Applies SBI specifically | Hybrid sheared-beam, holographic |
| SBI as reference | specifically | to holographic | approach |
| spot | developed for FDOS | reconstruction | No need for phase retrieval, is a direct |
| reconstructor | Reconstructs | Eliminates need for | consequence of Trex reconstructor |
| | reference spot | object reconstruction | which solves directly for complex |
| | complex field | from phase gradients | amplitudes using 3 illumination beams |
| | Interferes with flood | over full object extent | FDOS system parameters |
| | beam speckle pattern | | accommodate COTS |
| | | | implementation |
| | | | Best approach for FDOS |

The mathematics and reconstruction algorithm are discussed in detail below. These algorithms have been proven effective by Applicants in simulations.

### Technical Rational and Approach

A block diagram of the system is shown in FIG. 2. The system is broken down into three major subsystems: the Sensor, Lasers including beam steering optics, and Processor electronics. The Sensor block also contains the stereoscopic tracking/viewfinding cameras, and the Processor block also functions as the system controller and contains timing hardware. The following subsections describe the implementation of the RSH algorithm on the hardware.

### Holographic Image Reconstruction Algorithm

The Reference Spot Holographic (RSH) technique is based on a sheared beam imaging approach developed by Applicants. This sheared beam method takes advantage of the fact that by shearing the transmitter beams a shearing interference pattern is created at the target. If there is a phase offset between the sheared beams then they beat at the synthetic wavelength. The reflected signal off the target is collected by a receiver array that samples the speckle pattern at the pupil plane and forms an image from a time sequence of intensity measurements. Since only the intensity is measured by the technique it is insensitive to distortions in the optical path for the receiver.

### Algorithm Description

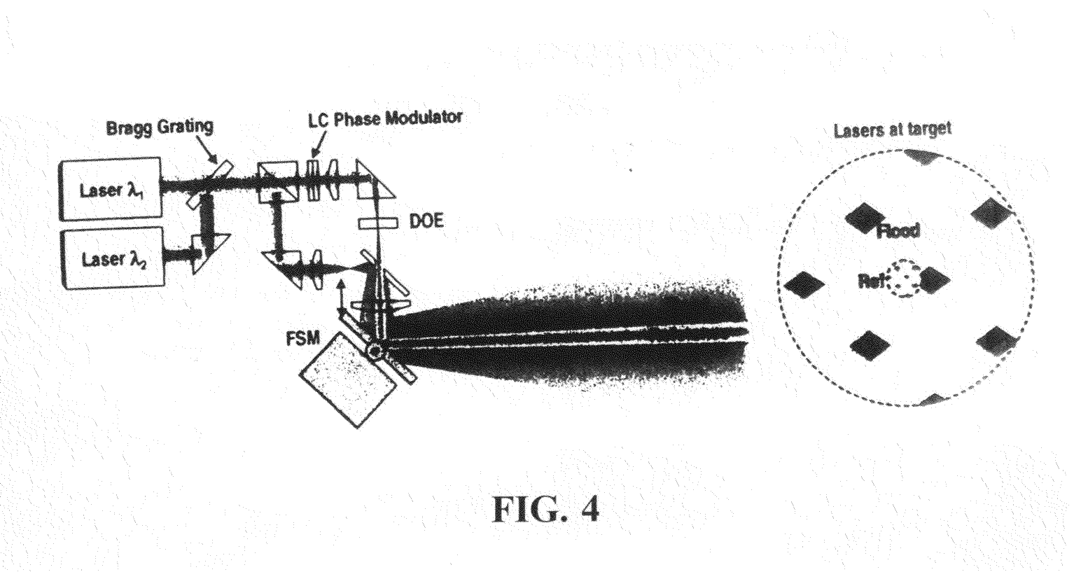

The RSH method is implemented by illuminating a target with 4 beams as depicted in FIG. 4. Three beams illuminating a small region on the target and form the reference spot and one flood beam illuminating the full target. In practice the area of the reference spot is significantly smaller in area than the full target size, on the order of 1/100^{th} the area. A 3-D image is formed through the use two separate wavelengths that are broadcast sequentially each with the four beams described above. The broadcast pattern for the three reference spots is an equilateral triangle with the flood beam broadcast from the center of the triangle.

The sheared beam amplitudes at the detector are:

a₁=\tilde{a}ₛₚₒₜ(\vec{x}+\vec{s₁})

a₂=\tilde{a}ₛₚₒₜ(\vec{x}+\vec{s₂})

a₃=\tilde{a}ₛₚₒₜ(\vec{x}+\vec{s₃})

where

ãₛₚₒₜ(\vec{x})

is the amplitude at the detector which would result from a target illumination with a single unsheared spot.

The (spot*spot) interferences extracted from the measurements are:

M₁₂=a₁ a̅₂̅+noise

M₂₃=a₂ a̅₃̅+noise

M₃₁=a₃ a̅₁̅+noise

Since the maximum baseline of the (spot*spot) interferences are small, namely the spot diameter, these data are highly overresolved. For computational efficiency, we therefore downsample this data with a filter before using and algorithm we refer to as the “HRI algorithm”:

Mᵢⱼ^{LPF}(\vec{x})=LPF(Mᵢⱼ(\vec{x}))

We pick the pixel separation in the downsampled data to adequately but not excessively sample the spatial frequencies, typically 1.5× Nyquist, but also to make the shears be an exact integer number of downsampled pixels.

The HRI reconstruction algorithm consists of a main complex amplitude update algorithm with two helper algorithms to improve convergence and robustness. More sophisticated algorithms have been used in the past to speed up convergence, but for a first demonstration simulation we used a simple implementation.

The algorithm starts with a guess, typically:

a_{rec}=1.

The main update algorithm is:

$${a}_{rec}^{new} = \frac{\begin{matrix}{M}_{12}^{LPF} ( \vec{x} - \vec{{s}_{1}} ) {a}_{rec} ( \vec{x} - ( \vec{{s}_{1}} - \vec{{s}_{2}} ) ) + \\ \overline{{M}_{12}^{LPF}} ( \vec{x} - \vec{{s}_{2}} ) {a}_{rec} ( \vec{x} - ( \vec{{s}_{2}} - \vec{{s}_{1}} ) ) + \\ {M}_{23}^{LPF} ( \vec{x} - \vec{{s}_{2}} ) {a}_{rec} ( \vec{x} - ( \vec{{s}_{2}} - \vec{{s}_{3}} ) ) + \\ \overline{{M}_{23}^{LPF}} ( \vec{x} - \vec{{s}_{3}} ) {a}_{rec} ( \vec{x} - ( \vec{{s}_{3}} - \vec{{s}_{2}} ) ) + \\ {M}_{31}^{LPF} ( \vec{x} - \vec{{s}_{3}} ) {a}_{rec} ( \vec{x} - ( \vec{{s}_{3}} - \vec{{s}_{1}} ) ) + \\ \overline{{M}_{31}^{LPF}} ( \vec{x} - \vec{{s}_{1}} ) {a}_{rec} ( \vec{x} - ( \vec{{s}_{1}} - \vec{{s}_{3}} ) )\end{matrix}}{\begin{matrix}{\vert {a}_{rec} ( \vec{x} - ( \vec{{s}_{1}} - \vec{{s}_{2}} ) ) \vert}^{2} + {\vert {a}_{rec} ( \vec{x} - ( \vec{{s}_{2}} - \vec{{s}_{1}} ) ) \vert}^{2} + \\ {\vert {a}_{rec} ( \vec{x} - ( \vec{{s}_{2}} - \vec{{s}_{3}} ) ) \vert}^{2} + {\vert {a}_{rec} ( \vec{x} - ( \vec{{s}_{3}} - \vec{{s}_{2}} ) ) \vert}^{2} + \\ {\vert {a}_{rec} ( \vec{x} - ( \vec{{s}_{3}} - \vec{{s}_{1}} ) ) \vert}^{2} + {\vert {a}_{rec} ( \vec{x} - ( \vec{{s}_{1}} - \vec{{s}_{3}} ) ) \vert}^{2} + ε\end{matrix}}$$

where E is a small regularization parameter. A smoothing filter is also applied each iteration after the above update.

This update converges fastest when the update is performed sequentially pixel by pixel, but it also works fine with full frame updates which are easier to efficiently code into processors. The highest spatial frequencies converge the fastest with this algorithm. We also periodically implement updates which specialize in low spatial frequencies.

The first low frequency update is a phase tilt fixer, which can be implemented by finding the values

arg(mean(M₁₂^{LPF}(\vec{x}) \overline{a_{rec}(\vec{x}+\vec{s₁})}a_{rec}(\vec{x}+\vec{s₂})))

arg(mean(M₂₃^{LPF}(\vec{x}) \overline{a_{rec}(\vec{x}+\vec{s₂})}a_{rec}(\vec{x}+\vec{s₃})))

arg(mean(M₃₁^{LPF}(\vec{x}) \overline{a_{rec}(\vec{x}+\vec{s₃})}a_{rec}(\vec{x}+\vec{s₁})))

which determine the error in the slope of the phase. This has also been implemented in patches in the past to improve convergence for intermediate spatial frequencies as well as the lowest spatial frequencies.

The second low frequency update is a phase wrap fixer. We essentially compare the normal update numerator,

M₁₂^{LPF}(\vec{x}−\vec{s₁})a_{rec}(\vec{x}−(\vec{s₁}−\vec{s₂}))+ M̅₁̅₂̅^̅{̅L̅P̅F̅}̅(\vec{x}−\vec{s₂})a_{rec}(\vec{x}−(\vec{s₂}−\vec{s₁}))+M₂₃^{LPF}(\vec{x}−\vec{s₂})a_{rec}(\vec{x}−(\vec{s₁}−\vec{s₃}))+ M̅₂̅₃̅^̅{̅L̅P̅F̅}̅(\vec{x}−\vec{s₃})a_{rec}(\vec{x}−(\vec{s₃}−\vec{s₂}))+M₃₁^{LPF}(\vec{x}−\vec{s₃})a_{rec}(\vec{x}−(\vec{s₃}−\vec{s₁}))+ M̅₃̅₁̅^̅{̅L̅P̅F̅}̅(\vec{x}−\vec{s₁})a_{rec}(\vec{x}−(\vec{s₁}−\vec{s₃}))

with clockwise and counterclockwise phase wrapped versions of the above value. If the ratio is above a threshold for a pixel, the reconstructed amplitude is multiplied by a phase wrap centered on the most offending pixel.

The net reconstruction algorithm is very robust, with excellent noise properties and practically no failures.

After the HRI algorithm is complete, we use filters to upsample the reconstructed amplitude,

a_{rec}^{UP}(\vec{x})≅ãₛₚₒₜ(\vec{x})

Now we use the (flood*spot) interferences extracted from the measurements:

M₀₁=a_{flood}\tilde{a}ₛₚₒₜ(\vec{x}+\vec{s₁})+noise

M₀₂=a_{flood}\tilde{a}ₛₚₒₜ(\vec{x}+\vec{s₂})+noise

M₀₃=a_{flood}\tilde{a}ₛₚₒₜ(\vec{x}+\vec{s₃})+noise

We use all of these to recover the flood amplitude to avoid speckles:

$${a}_{rec}^{flood} = \frac{{M}_{01} {a}_{rec}^{UP} ( \vec{x} + \vec{{s}_{1}} ) + {M}_{02} {a}_{rec}^{UP} ( \vec{x} + \vec{{s}_{2}} ) + {M}_{03} {a}_{rec}^{UP} ( \vec{x} + \vec{{s}_{3}} )}{{\vert {a}_{rec}^{UP} ( \vec{x} + \vec{{s}_{1}} ) \vert}^{2} - {\vert {a}_{rec}^{UP} ( \vec{x} + \vec{{s}_{2}} ) \vert}^{2} + {\vert {a}_{rec}^{UP} ( \vec{x} + \vec{{s}_{2}} ) \vert}^{2} + ε}$$

This is repeated for each wavelength used. We then computationally propagate the amplitudes to the target.

a_{rec}^{target}(\vec{x},λ)

For two wavelengths, we process the data by form the synthetic interference between the amplitudes at these two colors:

I_{phase encoded}=a_{rec}^{target}(\vec{x},λ₁) \overline{a_{rec}^{target}(\vec{x},λ₂)}

This synthetic interference has depth encoded as phase. The depth is ambiguous modulo 2n, however, so the synthetic wavelength should be chosen to be larger than the surface roughness. A synthetic wavelength that is too large is not desirable either, however, as small phase errors will translate to large depth errors in that case.

In the case of more than two wavelengths, we can transform the data in the wavelength dimension to for a 3D map without depth ambiguity. The desirability of more colors depends on detailed mission requirements.

### Simulation Results

The simulation object is a paraboloid with ripples. The depth parameter is in arbitrary units. The depth map, reveals low contrast depth ripples. The effect of the depth depends on the synthetic frequency, which gives a relative beat between the complex amplitudes of the two wavelengths. This data can be displayed by taking the phase of the synthetic frequency to color code the intensity. The square root is used as a kind of gamma correction to help display the data.

### The Illumination

The illumination is composed of 8 beams: two sets of 4 beams which are nearly identical but at offset wavelength.

Each wavelength uses 4 beams: 3 reference spot beams transmitted to the same location in the center, and 1 flood beam illuminating the region of interest. The beam profile for all of the spots is a Gaussian with a depression in the center to modestly help flatten the intensity profile. All beams are assumed to have the same total power in this case.

The difference beat between the two wavelengths creates a synthetic wavelength. This synthetic wavelength is used to measure depth, as there will be a relative phase shift in the amplitudes of the two wavelengths. One synthetic wavelength corresponds to 2π relative phase shift.

The flood beam diameter at 50% of center power is approximately ⅔ of the grid diameter, but there is some power that spills beyond that. The power at the edge of the grid is approximately 1% of center power. The flood beam intensity profile (binned 4×) is shown in FIG. 4.

The spot beams all have the same profile, 1/18 of the diameter of the flood beam. They are centered in the center of the grid. The spot intensity profile (binned 4×) is also shown in FIG. 4.

### Scattering

The beam returning from the object is assumed to have a complex multiplicative Gaussian random value applied at each pixel. This is a good approximation in the case that the surface is microscopically rough, or when the light penetrates the surface slightly. This scattering causes both a random phase and speckling of the intensity

We assume that the two illuminating wavelengths are close, so that the synthetic wavelength is much longer than the scattering length from the pixel. In that case, the complex random value from the scattering is the same for the two wavelengths. This assumption is critical to the technique.

Our objective is to interfere the flood beam amplitudes from the two wavelengths. We cannot do this directly, as the frequency difference is too large for low speed detectors. Instead, we must use a different technique to solve for the amplitudes of each wavelength individually, and then synthetically interfere the results in the computer.

### Grid

The grid at the object is 1536×1536. The part of the grid that is well illuminated is approximately 1024×1024. The detector is sized so that λ/D is the pixel size at the object. The maximum baseline at the object is the interference of the flood beam with the edge of the reference spot which is approximately 512 pixels. Thus, a detector with 1536 pixels takes 3 samples per wavelength of maximum baseline which is adequate. This also allows us to compute the propagation using 1536×1536 sized FFT's.

The reference spot transmitter shear offsets are 40 detector pixels from center, so that relative offsets in pairs are about 70 pixels, in roughly an equilateral triangle. Other shear values over a fairly wide range also work, so we have to evaluate what the ultimate best choice will be for that parameter.

The flood-spot interference data is used at full resolution. The maximum baseline of the spot-spot interference, however, is only around 60 pixels, however, so those beat components are immediately downsampled using spatial filtering. We used a factor of 8 downsampling to compute the inputs to the HRI sheared beam reconstructor algorithm.

### Measurements

The actual system modulates the phases of the eight beams, which are then processed to recover the individual beat components. There are 12 beat components which are used:

(2 colors)×(flood*spot 1+flood*spot2+flood*spot3+spot1*spot2+spot2*spot3+spot3*spot1).

In the most conservative embodiment, acquiring the 6 beats requires 13 frames of data. However, there is a disparity in spatial frequency strengths between the 3 flood/spot beats (which have mostly high spatial frequencies, and the 3 spot/spot beats (which are exclusively low spatial frequency). We thus believe that 7 frames of data are adequate using this innovative spatial separation technique.

The noise is applied as if 7 measurements are made, for which the noise level is

a=average(flood*flood+spot1*spot1+spot2*spot2+spot3*spot3)/(SNR*sqrt(7))

We used SNR=5 for the simulation, which appears to be conservative with regard to the reconstructor requirements.

### Spot Reconstructor

The reconstructor is applied separately and independently for the two wavelengths. The algorithm used was developed originally in the 1980's, and further refined in programs for satellite imaging.

The inputs to the reconstructor are the three spot*spot interferences. The sensor data is downsampled by a factor of 8×8 before input to the HRI algorithm. The DC components are not used.

The algorithm is mainly a complex amplitude update algorithm, with 2 other utility updates to help convergence. The overall algorithm seems to rarely if ever fail as long as the inputs are in an acceptable configuration at modest SNR.

After reconstruction, the solved amplitude is upsampled back to the full grid. The resulting Strehl is in the 0.98-0.99 range for the parameters used.

### Flood Beam Reconstructor

The flood beam reconstructor is also applied separately and independently for the two wavelengths. Once the spot beam amplitudes are reconstructed, they can be used as holographic references for the flood beam. It is advantageous to use a weighted average of all three reference beams to mitigate speckle in the reference. FFT's are used to backpropagate the amplitude to the target at the two wavelengths.

Finally, the amplitudes from the two wavelengths are in a form which can be interfered in the computer. This results in a speckled image, whose phase corresponds to the depth of the object. 2m shift corresponds to a depth change of one synthetic wavelength.

### Encoding/Decoding the Data

For each wavelength, there are four beams (3 shear reference spots plus 1 flood beam), which result in 6 cross interference terms. There is also a DC component which is not used in the reconstruction. The cross interference terms are (spot 1*spot2), (spot 2*spot3), (spot3*spot1), (flood*spot 1), (flood*spot2), and (flood*spot3).

If we just took the most straightforward approach, we could encode all of this information by shifting the phases of the four amplitudes, and collecting frames of data at the various phase shifts. Encoding 6 beats in this way would take at least 13 frames of data.

We can take advantage of a property of the data to reduce the number of frames taken, however. The (spot*spot) terms have very different spatial characteristics from the (flood*spot) terms; because of this, we can encode a pair of beat maps in a single frame. Specifically, the (spot*spot) terms are very limited in spatial frequency, determined by the maximum baseline which is the spot diameter. Thus, all of the (spot*spot) interference power is contained in <1% of the lowest spatial frequencies. The (flood*spot) data, however, is spread across all of the spatial frequencies.

We therefore are confident that we can encode the data in only 7 frames (per wavelength) of data by combining one (spot*spot) and one (flood*spot) pattern at each encoded frequency. The signal extraction step would then use both temporal transforms and spatial filtering to break the data into the interference terms used in the reconstruction.

As a backup for risk mitigation, we can alternatively measure the (spot*spot) beats separately, but only sparsely sample at very high frame rate. Another absolute worst case backup plan would be to be to increase the frame rate and take the full 13 frames of data, but we regard the need for that extreme as unlikely.

### Movement Correction

We mentioned that to encode the data we sample frames at 7 different phase offsets. We can correct for constant motions, however by adding a single additional 8th frame at the end at beam phases which match the initial frame. We then find the affine transformation which maps the first to the last frame, and linearly interpolate fractions of that affine transformation to the intermediate frames. This corrects all solid body movements of the target as long as the movement is constant and not too large. This is implemented in a preprocessing step to the main algorithm.

### Transmitter/Lasers

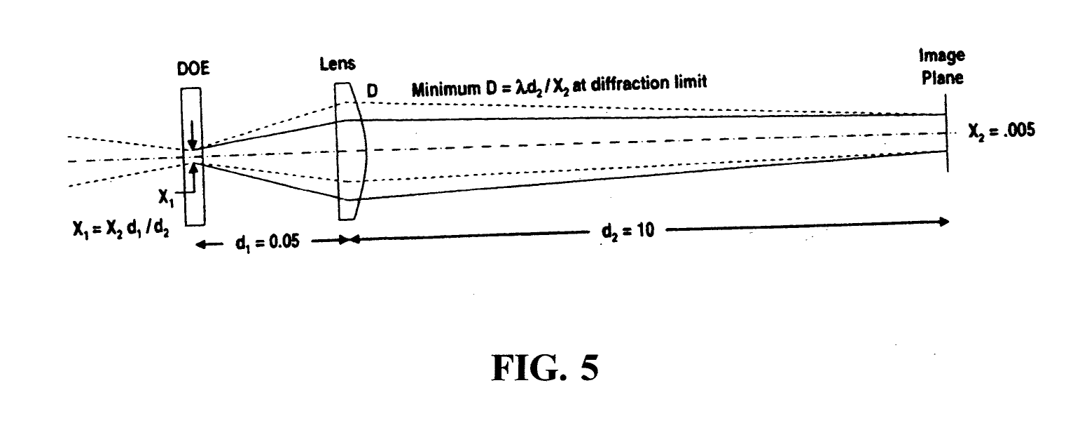

FIG. 4 highlights the lasers and beam steering optics in blue in the system diagram. The proposed shear beam technique requires that four beams illuminate the target. A flood beam fills the full target. Each of three reference spots fills a small portion of the target, about 5% linearly. These reference spots must coincide at the target but appear to be directed from locations at the beam origin separated by about 10 sampling pixel pitches. This separation is smaller than the spot size out of the laser and for Case 2 represents a beam angular separation of only about 0.02 mrad. This task is difficult to achieve with bulk optics. So Applicants in preferred embodiments perform the beam shearing with a diffractive optical element (DOE) that sends one third of the incident light into each of three output beams, a zero-order beam and two diffracted beams, making horizontal and vertical angles of about 0.02 mrad with the zero-order output. The scheme is diagramed in FIG. 5. A lens with the DOE and target at conjugate points directs the sheared reference beams to the same target location. Appropriate choice of the parameters shown in the figure allows it to scale to the various target ranges.

Applicants' image reconstruction algorithm relies upon multiple wavelengths, provided by the two lasers, and multiple redundant reference phases, provided by the electronically tunable liquid crystal phase modulator. First, the output of the two lasers is combined and then a portion is split off to be diverged into the flood beam. The reference beam has a controllable piston phase delay applied before being sheared by the DOE. The reference and flood beams are then recombined to share a common output aperture. They are steered with a fine steering mirror (FSM). Commonly available steering mirrors are typically coated to optimize performance in visible and infrared spectral regions.

The laser beam diameter at target is L and the target range is R, and the speckle size is d, then,

$$d = \frac{λ R}{L}$$

For Nyquist sampling, the pixel pitch of an imaging sensor, d₀, should be half of d. The illumination energy (J) per exposure time tₑₓₚ, (<=1/PRF) (or energy per pulse) at target is

$${E}_{target} = \frac{{P}_{t}}{PRF} {τ}_{atm}$$

Where, PRF is the laser pulse rep rate which equals to the sensor frame rate, and Pt is the averaged transmitter output power. For pulsed laser, its energy per pulse is

$${E}_{t} = \frac{{P}_{t}}{PRF}$$

The reader should note, τₐₜₘ represents the air transmission. The solid angle opened by one sensor pixel at the receiver, with respect to a point on the target, is:

ΔΩ=d₀²/R²
(U) Assuming that the target is Lambertian surface with a normalization of π steradians (not 2π) and with its reflectance alb, the received energy per sensor pixel per exposure (gate-on) period, tₑₓₚ, is

$${E}_{r} = \frac{Δ Ω}{π} \cdot alb \cdot {E}_{target} \cdot {τ}_{atm} \cdot {τ}_{opt} .$$

(U) Here, τₒₚₜ is the receiver's optical transmission. The photon electron count at sensor per pixel during the period of tₑₓₚ is

$${N}_{e} = \frac{{E}_{r}}{\frac{hc}{λ}} {η}_{e} .$$

(U) Combining all those equations, the photon electron count is expressed as

$${N}_{e} = \frac{λ \cdot alb \cdot {d}_{0}^{2}}{π {hcR}^{2}} \frac{{P}_{t}}{PRF} {τ}_{atm}^{2} \cdot {τ}_{opt} \cdot {η}_{e} .$$

(U) For a given Nₑ, the total required transmitter power can be expressed as

$${P}_{t} = PRF \cdot {N}_{e} \frac{π hc}{λ} \frac{1}{alb \cdot {τ}_{atm}^{2} \cdot {τ}_{opt} \cdot {η}_{e}} {( \frac{R}{{d}_{0}} )}^{2}$$

(U) If we express SNR as

$$SNR = \frac{{N}_{e}}{\sqrt{{N}_{e} + {N}_{solar} + {DN}^{2}}} ,$$

then we have

$${N}_{e} = \frac{1}{2} {SNR}^{2} [ 1 + \sqrt{1 + \frac{4 ( {N}_{solar} + {DN}^{2}}{{SNR}^{2}}} ] ,$$

where Nₛₒₗₐᵣ is the photo-electron count for the same exposure period and DN is the dark noise per sensor reading. We then have our final relation for estimate photon budget as

$${P}_{t} = PRF \cdot \frac{1}{2} {SNR}^{2} [ 1 + \sqrt{1 + \frac{4 ( {N}_{solar} + {DN}^{2}}{{SNR}^{2}}} ] \frac{π hc}{λ} \frac{1}{alb \cdot {τ}_{atm}^{2} \cdot {τ}_{opt} \cdot {η}_{e}} {( \frac{R}{{d}_{0}} )}^{2} ,$$

or for transmitter output energy per pulse as

$${E}_{t} = \frac{1}{2} {SNR}^{2} [ 1 + \sqrt{1 + \frac{4 ( {N}_{solar} + {DN}^{2}}{{SNR}^{2}}} ] \frac{π hc}{λ} \frac{1}{alb \cdot {τ}_{atm}^{2} \cdot {τ}_{opt} \cdot {η}_{e}} {( \frac{R}{{d}_{0}} )}^{2}$$

### Laboratory Validation

A lab experiment may be performed to test and validate the concept of RSH in both the spatial resolution that can be reconstructed and the 3-D target depth that can be measured. Two major tasks are proposed to achieve this goal. First, demonstrate the required spatial resolution with a 2-D imaging experiment which will confirm that RSH can significantly reduce sensor data processing time. The test may utilize a transmitter for the RSH lab experiment at a wavelength of 532 nm. Using a 2 k×2 k COTS video camera as the receiver, 2-D images of static reflective targets can be generated. The second task will require a tunable laser for the transmitter laser in order to obtain 3-D imaging capability. The tunable laser is used to generate a synthetic wavelength given by:

$${λ}_{synthetic} = \frac{{λ}_{1} * {λ}_{2}}{( {λ}_{1} - {λ}_{2} )}$$

that is larger than the anticipated depth profile of the target used. High spatial resolution and its 3-D imaging capability by RSH are main features to be validated in this lab experiment.

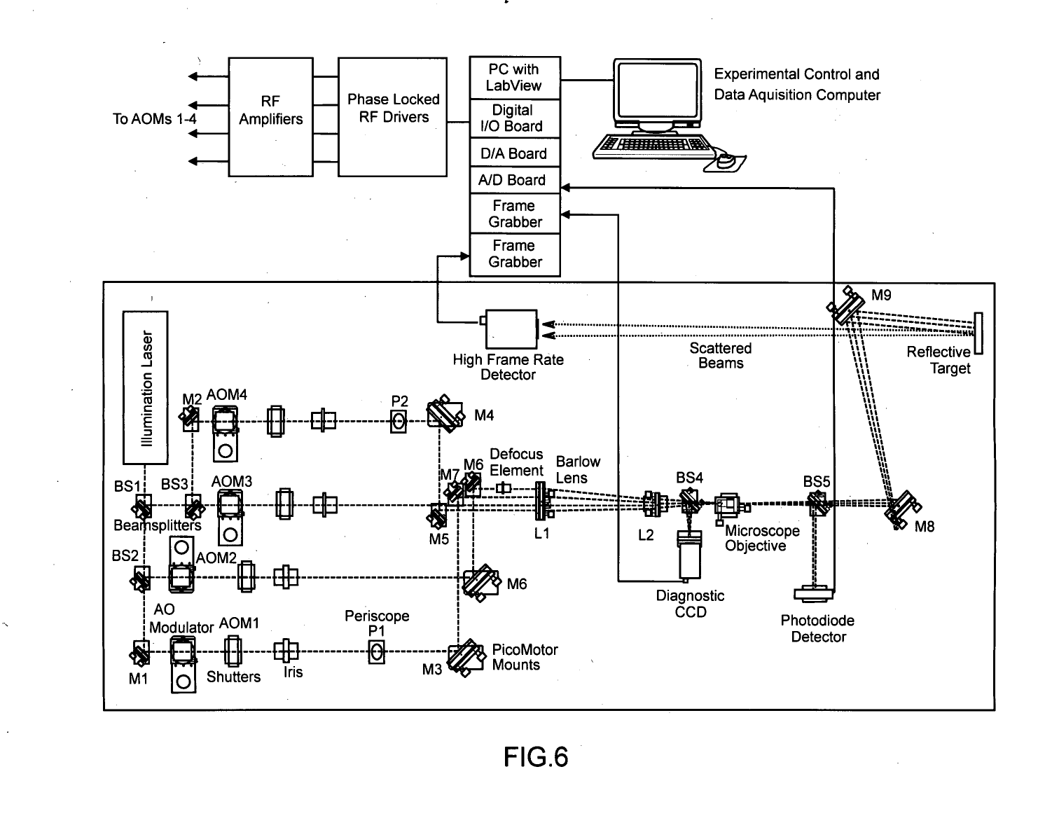

FIG. 6 illustrates the optical layout for a RSH lab experiment. The output of a laser beam is first split into four beams and each beam is frequency shifted by a given value tₒ using acousto-optic modulators (AOM). All four AOMs are phase locked so that all the frequency shifted beams preserve their coherent phase relation. The beams are then arranged by a set of periscopes and mirrors in a spatial orientation such that the three reference beams are at the vertices of an equilateral triangle and the flood beam is slightly offset from the reference beams. A lens is then used to propagate the beams to the far-field. The lateral shear of the beams in the near-field results in an interference pattern superimposed on the beam's point-spread function (PSF) in the far-field. A defocusing element is used in one of the beams to create an approximately 10× times larger diameter beam in the far-field for the flood beam.

Since the PSF of the beams at the focus of the lens is very small in comparison to the desired size on the reflective target, a microscope objective will be used to reimage and magnify the focal plane on the beams onto the target. A diagnostic video camera is used to verify and set the spot overlap at target plane. Feedback will be provided to picomotor actuators so that the beams stay well overlapped at the target plane. Also, a fast photodiode detector is used to monitor both the beam modulation frequencies and the output power amplitude at the target plane. An experiment control computer running Lab View will be used to control the laboratory setup and provide a GUI interface to the user.

For the receiver sensor a high frame rate camera (Redlake Y5) is used to record the modulated speckle patterns which result from the interference of the scattered beams from the target. The IDT (Redlake) Y5 camera has 2560×1920 pixel resolution and up to 625 fps frame rate. The data streaming from the imaging sensor camera is collected and stored by the experiment control computer. Applicants' 3-D imaging reconstruction program will then process and convert the complex speckle data recorded on the receiver sensor into a high resolution image of the target. Thus, the laboratory setup will be used to demonstrate both the 3-D RSH spatial resolution and the depth profile resolution under realistic conditions.

### Anticipated Results and Exit Criteria for the RSH Lab Experiment

The first major objective of the laboratory experiment is to demonstrate a RSH imaging algorithm that obtains the desired imaging spatial resolution at a greatly reduced data process time. We will meet this objective utilizing the current Active Imaging setup with a 2-D imaging demonstration at 532 nm. The ability to utilize a laboratory setup that is currently operational is very important in order to quickly start to test the reconstruction algorithms which will expedite the designs for the hardware.

### Variations

The above described embodiments of the present invention have been described in detail. Persons skilled in the art will recognize that many variations of the present invention are possible. For example, units can be customized to support imaging that occurs in field operations such as in law enforcement and military operations. Potential applications include physical security and tactical surveillance.

Therefore, the scope of the present invention should not be limited to the above described preferred embodiments, but by the appended claims and their legal equivalence.

What is claimed is:

1. A high resolution 3-D holographic camera for producing 3-D holographic images of a target, said camera comprising:
A) a first laser system adapted to produce three spatially separated beamlets, simultaneously produced from a single laser beam, for producing a lateral shear of a wavefront on the target,
B) a second laser system adapted to produce a flood beam for illuminates the entire target,
C) a many pixel sensor system adapted to measure and record the reflected flood beam and the resulting reflected speckle intensity pattern to determine object spatial frequencies, and
D) a computer processor programmed with an algorithm adapted to:
1) sequence in time the illumination patterns, stepping through offset phase shifts to provide data necessary to reconstruct an image of the target from the recorded reflected light,
2) reconstruct spot phase and amplitude,
3) digitally interfere a complex field of a reference spot with flood illuminated speckle field by using a special algorithm to obtain a first high resolution 3D image of the target,
4) repeat sub-steps D1), 2) and 3) the laser beam slightly shifted in frequency to obtain a second high resolution 3D image of the target, and
5) utilize the two images at slightly offset frequencies to compute a depth profile of the illuminated target.

2. A process for acquiring a high resolution holographic image of a target comprising steps of:
A) producing three laser beamlets from a single laser beam and directing the three beamlets simultaneously to the target to produce a lateral shear of a wavefront on the target,
B) illuminate the target with a separate laser flood beam,
C) with a many pixel sensor measure and record the reflected flood beam and resulting speckle intensity pattern to determine object spatial frequencies,
D) with a computer processor programmed with a special algorithm sequence in time illumination patterns, stepping through offset phase shifts to produce data necessary to reconstruct an images of the target from recorded reflected light so as to reconstruct spot phase and amplitude,
E) digitally interfere a complex field of a reference spot with flood illuminated speckle field by using a special algorithm to obtain a first high resolution 3D image of the target,
F) repeat sub-steps D1), 2) and 3) the laser beam slightly shifted in frequency to obtain a second high resolution 3D image of the target, and
G) utilize the two images at slightly offset frequencies to compute a depth profile of the illuminated target.
